(19) United States
(12) Patent Application Publication
(10) Pub. No.: US 2005/0071223 A1
(43) Pub. Date: Mar. 31, 2005

(54) Method, system and computer program product for dynamic marketing strategy development

(76) Inventors: Vivek Jain, New Delhi (IN); Karumanchi Ravikumar, New Delhi (IN)

Correspondence Address: T. Rao Coca;IBM Corporation, Almaden Research Center, 650 Harry Road, San Jose, CA, 95120, US

(21) Appl. No.: 10/674,312

(22) Filed: Sep. 30, 2003

(51) Int. Cl. G06F 17/60

(52) U.S. Cl. 705/14

(57) ABSTRACT

A method, system and computer program product for dynamically developing an optimal marketing strategy is disclosed. The method first optimizes the marketing strategy on the basis of customer responses and preferences. The history of customer response for the strategy, or for other similar strategies, is used in this step. Reinforcement learning in constrained domains is then used to further optimize the strategy. The constraints imposed in this step are attributed to multiple marketing channels, which are used to deploy the strategies. The constraints include the cost and the effectiveness of the marketing channel and the customer preferences for the marketing channel. The optimized strategy is then deployed, and the customer response is recorded. The method is executed repeatedly for a specified duration.

### FIELD OF THE INVENTION

The present invention relates to generating a marketing strategy to meet predefined business objectives. In particular, the present invention relates to dynamically developing optimal marketing strategies, by considering the involved constraints, so as to meet business objectives over a specified period of time.

### BACKGROUND

One of the common problems faced by a number of business organizations worldwide is planning their growth in a structured manner. In order to plan the growth, the organizations need to have a set of business objectives. These business objectives define an organization's growth plans for a particular span of time. At any point in time, a business organization may have multiple business objectives with each business objective relating to planned growth in a particular segment or an area. A company having multiple product lines may have different business objectives for each line of products. For instance, the business objective of an organization for product A may be to maximize cash profits, whereas for product B it may be to increase awareness about the product.

In order to address multiple business objectives, organizations develop and implement a number of strategies. Marketing strategy is an important aspect that organizations have to consider keeping in view their business objectives. A typical marketing strategy involves a set of initiatives offered by the organization across various marketing channels. For instance, marketing strategy for product A may be: offer a discount of 5% on purchase of product A when it is purchased over the Internet. Some examples of initiatives include bundling of products, cross-sells, up-sells, attributes of the product, expert opinions about the product, coupons, discounts, promotions, advertisements, surveys, customer feedbacks and the like. Marketing channels are the media through which an organization reaches and interfaces with the customers. Examples of marketing channels include PDA devices, mobile phones, tablet PCs, PCs, e-mails, web interfaces, newsletters, magazines, television, direct marketing and the like.

Traditionally, organizations rely on the experience of its employees, and consultations from external experts in order to develop and implement a marketing strategy. The employees and external experts, in turn, base their recommendations on the marketing strategies adopted by the organization in the past (or marketing strategies adopted by other organizations in similar industries), and the results achieved by implementing such marketing strategies. The underlying idea used for developing a marketing strategy involves the incorporation of customer response and customer preferences. This idea is now explained in greater detail.

Development of a marketing strategy is affected by the history of customer responses. The implementation of the developed strategy, in turn, affects the present and future customer responses. When a marketing strategy is implemented, the generated customer response reflects the efficacy of the marketing strategy. Indeed, a bad marketing strategy may result in traumatic customer experience, and hence in a bad customer response. A bad customer response is indicative of further impairment in an organization's ability to sell to the customer in future. This deters organizations from indulging into large-scale experimentation while developing strategies, and the organizations continue to rely on conventional tried and tested methods. This also prevents the usage of customer response obtained upon implementation of a marketing strategy in order to further modify or develop the strategies as per the changing needs and profiles customers. Clearly, this is a limitation that organizations would like to overcome.

Development of marketing strategies is also governed by customer preferences, which are gauged by customer responses. For instance, a bad response to the use of newspapers as the marketing channel may force the organization to use television as the preferred marketing channel. Customer preferences also enable the organizations to partition customers into unique identifiable groups. The needs of these groups can be addressed collectively by developing a common marketing strategy.

Customer preferences are primarily defined by two sub-factors: customer preferences for various initiatives offered by the organization, and customer preferences for various marketing channels used by the organization. Clearly, there are certain limitations/constraints in the choice of initiatives and/or marketing channels. First constraint is the cost of employing the marketing channel as a part of the marketing strategy. For instance, use of television as a marketing channel is costlier than the newspapers as marketing channels. Thus, if the budget is limited, newspaper may turn out to be the preferred marketing channel. Second constraint is the effectiveness of the employed marketing channel in terms of its reach and contribution towards the end objective. For instance, if the objective is to gain a greater market share, newspaper will be the preferred marketing channel over, say the Internet or the PDA, which has lower reach to the masses as compared to newspapers. Third constraint is the customer profile and customer preference for one marketing channel over another. For instance, a marketing strategy for online sale of anti-virus software would prefer the Internet as the marketing channel rather than choosing other channels, such as the radio.

Therefore, it is desirable for an organization to have a marketing strategy that is optimized by taking into account the above constraints imposed by multiple marketing channels. The marketing strategy must further be optimized for a customer segment. Further, an organization must have the freedom to control the marketing strategies as well.

A number of solutions that attempt to address the above problems, either partially or completely, exist in the art. U.S. patent application publication US20020013776A1, titled “A method for controlling machine with control module optimized by improved evolutionary computing”, describes a method that uses genetic algorithm to generate population of individuals for arriving at a method of controlling the machine. However, this solution is based on genetic algorithm and does not address the issue of constraints imposed by multiple marketing channels.

Another U.S. patent application publication US20020062481A1, titled “Method and system for selecting advertisements”, describes a method of displaying interactive advertisements on a television having controller which makes use of reinforcement learning based feedback from viewers. However, the invention focuses on a viewer in a single marketing channel, and does not relate to optimal marketing strategy for a segment of customers.

A paper titled “Sequential cost sensitive decision making with reinforcement learning” by Edwin Pednault, Naoki Abe, Bianca Zadrozny, Haixum Wang, Wei Fan and Chidanand Apte, published in KDD 2002 describes a sequential decision making process. State of customers is represented by demographics and recency, frequency and amount based parameters of the promotions received by the customers. However, this solution does not address the issue of multiple channels and constraints imposed by each channel.

Therefore, what is needed is a method of developing marketing strategies that addresses the issue of multiple marketing channels and constraints imposed by each channel. The developed marketing strategy should involve minimal experimentation and should be optimized across the multiple channels and across different customer segments. It is also desirable that changing customer responses are used to dynamically alter and develop the marketing strategies. Further, the organization should have a control on the development and implementation of the marketing strategies.

### SUMMARY

A general objective of the present invention is to provide a method, system and computer program product that develops an optimized marketing strategy by considering multiple marketing channels and multiple customer segments.

Another objective of the present invention is to provide a method that optimizes marketing strategies on the basis of constraints imposed by marketing channels.

Another objective of the present invention is to use customer responses and customer preferences for dynamically developing an optimized marketing strategy.

Yet another objective of the present invention is to enable organizations to exercise more control in the process of development and implementation of marketing strategies at any instance of time.

Yet another objective of the present invention is to reduce the level of experimentation and uncertainty in developing an optimized marketing strategy.

In order to attain the abovementioned objectives, a method, system and computer program product for developing an optimized marketing strategy is provided. An organization first defines its objectives using a merchant objective specification tool. The objectives are typically constrained by a time span and a budget specified by the organization. Different marketing strategies are then generated in order to meet the above objectives. By using reinforcement learning in constrained domains, an optimal strategy is identified. Reinforcement learning takes into account the constraints imposed due to multiple marketing channels while identifying an optimal strategy. The constraints include cost, effectiveness and customer preferences for various marketing channels. Existing states of customers are also considered in the step of identifying an optimal strategy. History of customer responses to the strategy, or to other similar strategies, is thus used in this step. The identified optimal marketing strategy is then deployed and the obtained customer responses are recorded. The history of customer response is then updated with responses for the deployed strategy. The process of identifying optimal marketing strategy, deploying the strategy, recording the customer responses and updating the history of customer responses is then repeated for the complete time span specified for the objective.

### BRIEF DESCRIPTION OF THE DRAWINGS

The preferred embodiments of the invention will hereinafter be described in conjunction with the appended drawings, provided to illustrate and not to limit the invention and in which like designations denote like elements.

FIG. 1 shows a flowchart illustrating an overview of the method in accordance with a preferred embodiment of the current invention.

FIG. 2 is a block diagram depicting an overview of a system suitable for the implementation of an embodiment of the current invention.

FIG. 3 is a flowchart depicting the interaction of a shopper with the system described in FIG. 2.

FIG. 4 is a flowchart depicting the reinforcement learning algorithm, as it exists in the art

FIG. 5 is a flowchart depicting the constrained reinforcement learning algorithm in accordance with a preferred embodiment of the current invention.

FIG. 6 illustrates a computer system for implementing the present invention.

### DESCRIPTION OF PREFERRED EMBODIMENTS

Terminology Used

Decision Epoch: These can be either fixed epochs over time or epochs with random interval length (for instance, whenever a customer records a new purchase). The time period can be as short as a fraction of a second and as large as few hours or days. The choice of time period is a trade-off between faster learning and computing power. Given cheap computing power these days, the time period can be relatively short. It is assumed that the decision epochs span a sufficiently long time horizon.

State: State is identified by a set of variables such as customer profile, purchase frequency, monetary value of purchases and any other quantifiable measure so that a customer at any event or at any decision epoch can be uniquely identified to belong to a state in the space, S, described by the above set of variables. A typical customer's purchase pattern over time defines a trajectory over this space. In context of this invention, state in the reinforcement learning algorithm always refers to state of the arriving customers.

Marketing initiatives: Marketing initiatives are individual steps taken to promote a product. Some examples of initiatives are an advertisement being offered on Television, a coupon offered in a print medium or the Internet and a free product insert in the brick and mortar world.

Marketing strategy: A marketing strategy comprises a set of marketing communications or initiatives, which are deployed together in a given sequence for a specified period of time. The specified period of time may correspond to a decision epoch. A strategy might comprise of multiple initiatives in conjunction with each other, for example, an advertisement being offered on Television, a coupon in the print medium or the Internet and a free product insert in the brick and mortar world. Each of these initiatives may be deployed for variable time period and the sum total of the deployment time of all initiatives is the time period of the marketing strategy. A combination of these initiatives and channels might be evaluated and the optimal marketing strategy determined. Since a marketing strategy corresponds to a set of initiatives, the actual implementation of the strategy may involve several marketing channels, with each initiative being marketed using at least one marketing channel. For example, the merchant may choose to offer discount coupons over the Internet, as well print some coupons on certain magazines and freely distribute it in a door-to-door campaign. Therefore, the optimal marketing channels are identified for each initiative in the strategy.

Action: At a decision epoch t, an action aₜ(x) is a marketing decision taken in state x. The action taken corresponds to a marketing strategy and is deployed between two decision epochs or until an event occurs. The reinforcement learning algorithm determines the optimal policy (which spans across multiple decision epochs based on given set of information available with the system), which comprises multiple actions (that is, marketing strategies).

Policy: In the context of reinforcement learning algorithm, a policy corresponds to a sequence of actions at different states encountered over time during the decision phase spanning the entire planning horizon. A policy may be deterministic with an action specified for each time epoch, for example, a policy p={a₀, a₁, a₂, a₃, . . . aₙ} where the planning horizon has “n” decision epochs. Also, a policy may be probabilistic where the choice of an action is not definite. For example, the action taken for decision epoch tᵢ may be determined from a probability distribution, pdᵢ=[prᵢ(a₀), prᵢ(a₁), prᵢ(a₂), prᵢ(a₃), . . . prᵢ(aₘ)], where m is the total number of actions. The action to be executed is determined based on coin toss or a random number generator to simulate the probability distribution. The policy thus comprises a set of probability distributions, p={pd₀, pd₁, pd₂ . . . pdₙ}, with each probability distribution specifying the probability with which a particular action is taken in that decision epoch.

Value of a Policy: Value of a policy is a vector of total expected rewards. Each element of the vector corresponds to a state and represents the total expected reward for the policy for that state.

Planning Horizon: Planning horizon is the time period for which the reinforcement learning optimizes the Policy. For example, the merchant might look for an optimal plan for 5 years or a plan for few months. This planning horizon is divided into smaller time units, or decision epochs. At the beginning of each month he aims to find a strategy to be followed for the ensuing month given the history till that month. A policy is a specification of the sequence of (monthly) strategies to be followed over the planning horizon, while a strategy refers to individual month. The assignment of significance value to an action results from a consistency condition defined through dynamic programming over the entire time horizon. That is, if a sub-policy is generated from an optimal policy (for the full horizon) by removing strategy for the initial month, then the sub-policy should be an optimal policy for the (sub)-horizon starting from the second month.

Immediate Rewards: In the setting of the current invention, these immediate rewards measure the monetary value of the customer activity or reactions to marketing strategy, between two successive decision epochs for a given state and for an executed action. This is a random value depending on the effect of marketing action taken and also on the random time interval between epochs. In reinforcement learning, these immediate rewards define the needed reinforcement signal and measure the immediate effect of the marketing decision. An immediate reinforcement (reward) measures only short-term effects, positive or negative. A myopically optimal strategy can have adverse effects in future. For instance, a promotional activity may lead to immediate rise in sales of a product but as a result demand over subsequent periods might drop since the customers might have stockpiled the product, during the period of promotion, for a later use. Reinforcement learning assigns only a partial significance value to immediate effects of any executed marketing action. Significance value of an action measures the impact of the marketing action by weighing the immediate rewards against future revenues. This significance value of an action is constantly updated as learning progresses. The significance value is represented by Q(s,a), which measures the overall reward expected by executing strategy “a” whenever “x” is encountered. Reinforcement learning algorithms therefore optimizes over Value of a Policy and not on immediate rewards.

Markov Decision Process: A process in which the decision depends only on the current state. At a decision epoch t, an action aₜ(x) is a marketing decision taken for all customers in state x. The action taken for a customer depends only on the state of the customer. Hence, when a customer is considered during two decision intervals, his state is identified and an appropriate state dependent marketing decision is taken. The effect of time component of customer activity is absorbed in the set of variables (for instance frequency of purchase or how recent a purchase is) that define the state space. Therefore, it is not required to factor in the time component in deciding the actions.

Overview of the Invention

The current invention provides a method, system and computer program product for developing an optimal strategy for achieving a specified objective or a set of objectives for a particular product or a line of products. An organization can specify an objective or a set of objectives that he/she desires to achieve in a particular time frame. There can be more than one marketing strategy that can be used to achieve the desired objective. The current invention generates a set of possible marketing strategies that can be used and thereafter evaluates each strategy across multiple marketing channels and selects an optimal multi-channel marketing strategy that can be used. Further, this strategy is dynamically updated using constrained reinforcement learning (to be explained in detail later).

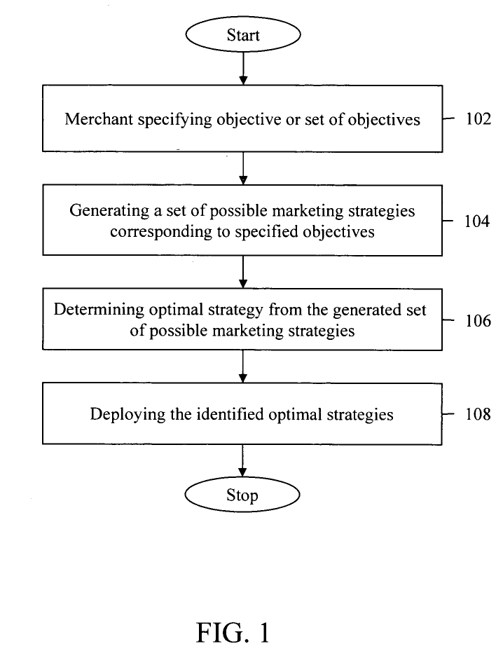

FIG. 1 shows a flowchart illustrating an overview of the method in accordance with a preferred embodiment of the current invention. The merchant specifies an objective or a set of objectives for a context at step 102. The context may relate to a particular product or a line of products of the merchant, particular customer or customer segment, particular competitor or set of competitors, particular geographical region or set of regions, particular time period or set of time periods, particular culture or set of cultures, particular socio-demographic-political situations or set of situations, and particular event or set of events and so on. For example, the objective for a product can relate to gaining the top market share for that product. A merchant can also have several objectives corresponding to a single product. For example, it may focus on maximizing profits from an already established customer segment, and increasing awareness about the same product in another customer segment. Similarly, a company having multiple product lines can have different objectives for each line of products.

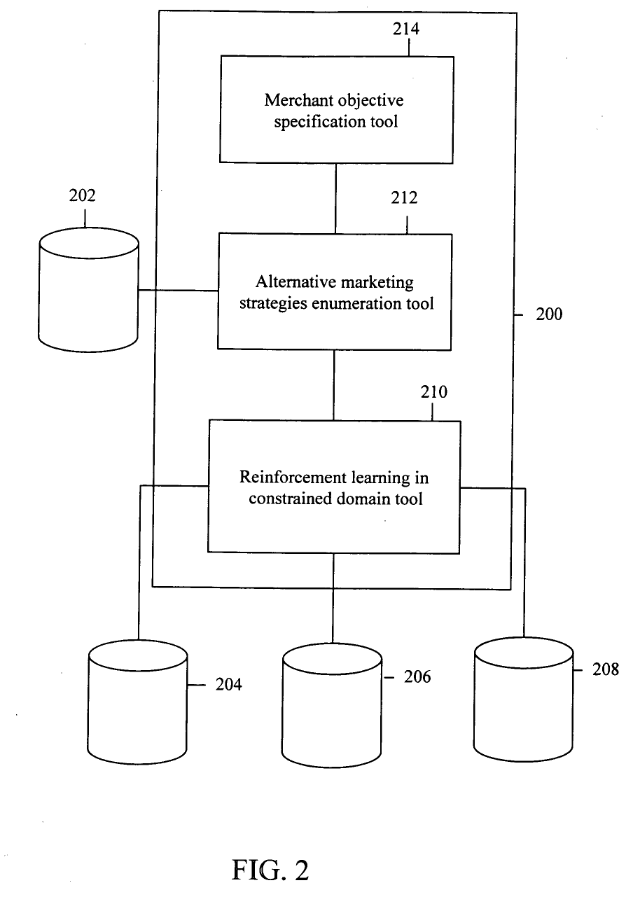

A set of possible marketing strategies, corresponding to the specified objective or set of objectives, are generated at step 104. A marketing strategy comprises a set of marketing communications or initiatives, which are deployed together in a given sequence for a specified period of time. The initiatives that can be offered to the customer can be specified by the merchant or can be selected from a list of initiatives stored in the Library of Base Initiatives (explained in detail in conjunction with FIG. 2). The merchant can specify conditions, such as the cost and the budget constraints that need to be taken care of while generating the strategies. These conditions can also be applied while generating the set of possible marketing strategies for the specified objectives. Details on how the marketing strategies are generated will be explained further in conjunction with FIG. 2.

Each marketing strategy generated at step 104 is evaluated at step 106 to obtain an optimal strategy corresponding to the specified merchant objective or set of objectives. The optimization of the marketing strategy is done using constraints corresponding to their implementation across different marketing channels. Each marketing strategy can be implemented across multiple channels. However, the cost involved and the effectiveness of a marketing strategy across each channel will vary. Further, customer preference may vary for different channels. Therefore, the marketing strategies are optimized across the set of marketing channels.

Since a marketing strategy corresponds to a set of initiatives, the actual implementation of the strategy may involve several marketing channels, with each initiative being marketed using at least one marketing channel. For example, the merchant may choose to offer discount coupons over the Internet, as well print some coupons on certain magazines and freely distribute it in a door-to-door campaign. Therefore, the optimal marketing channels are identified for each initiative in the strategy. In addition, a strategy might comprise of multiple initiatives in conjunction with each other, for example, an advertisement being offered on Television, a coupon in the print medium or the Internet and a free product insert in the brick and mortar world. A combination of these initiatives and channels might be evaluated and the optimal marketing strategy determined. The optimization may be dependent on the cost of implementation of the initiative on a channel, as well as the effectiveness of the channel. In a preferred embodiment of the present invention, a modified Reinforcement Learning (RL) algorithm is used for arriving at an optimal marketing strategy. The modified algorithm takes into account the cost and effectiveness of a channel as well as the preference of a customer towards a channel while evaluating a marketing strategy. The exact manner in which the modified RL algorithm utilizes the state of a customer and the cost and effectiveness of a channel to arrive at an optimal strategy will be explained in detail later.

Once each marketing strategy has been optimized, the best marketing strategy from the set of optimized marketing strategies is deployed at step 108. The multi-channel enabled commerce system has ability to address customer across multiple channels. If the customer visits one of the selected channels, the marketing initiative would be offered to the customer in accordance with the optimal marketing strategy. If the channel chosen is mail-in-rebate or e-mail, the marketing initiative would be offered to the customer either immediately by sending in an e-mail or mailed to the customer or based on an event-trigger mechanism which would monitor the event triggers which are part of the marketing strategy. There can be two instances of marketing initiative deployment: either the customer approaches the merchant through a marketing channel (for example, by visiting a brick and mortar store or an Internet store or by placing a call to the merchant's customer service or call centers) or the merchant approaches the customer through e-mails or calls placed to customer's contact numbers or promotion material sent to customer provided addresses. Customer preferences on being approached through a channel may be respected. In this manner, an optimal multi-channel strategy is identified in order to achieve the merchant's objective.

In an embodiment of the present invention, the optimal strategy is regularly updated based on customer response to a particular strategy. The update can be periodic. The update can also be user-initiated, i.e., whenever a customer visits the merchant, his/her response is taken into account in the next optimization of the marketing strategy.

Having provided an overview of the working of the present invention, the system in accordance with a preferred embodiment of the present invention will be explained hereinafter.

FIG. 2 is a block diagram depicting an overview of a system suitable for the implementation of the current invention. The system 200 comprises a merchant objective specification tool 210, an alternative marketing strategies enumeration tool 212 and reinforcement learning in constrained domains tool 214. Alternative marketing strategies tool 212 is connected to a library of base initiatives 202. Reinforcement learning in constrained domains tool 214 is connected to a library of multiple marketing channels 204, a library of cost and effectiveness of marketing channels 206 and a library of shopper profile 208.

Library of Base Initiatives 202 comprises a list of initiatives that can be offered to a shopper by the merchant. These include products and information about bundles, cross-sells, up-sells, accessories, customer opinions about a product, expert opinions about the product, products similar to a product, attributes of a product and the like. It also includes coupons, discounts, promotions, advertisements, surveys and customer feedback. Typically, such information can be stored in a database, and regularly updated. Further the merchant or the company can include specific initiatives.

Each marketing initiative has a set of parameters. For example, a coupon contains parameter like offer conditions, redemption conditions and the monetary value. The merchant can define lower and upper bounds, or may be specific values that each parameter of an initiative can take. For example, a 5% coupon for V-neck Sweater may have lower bound of 0% and upper bound of 30%. It must be apparent to one skilled in the art that although certain initiatives have been mentioned here, the library can include any other initiative without deviating from the scope of the present invention.

Library of Marketing Channels 204 comprises a list of marketing channels available to the merchant. These can include PDA devices, mobile phones, tablet PCs, PCs, e-mail, web interface, newsletters, magazines, television, telemarketing, direct selling and the like.

Library of Cost and Effectiveness of Marketing Channels 206 contains the cost of sending a marketing message to the shoppers using a particular marketing channel and its effectiveness over a broader population. It is well known from advertising agencies that newspapers, magazines (news, entertainment, specific socioeconomic groups) and Television have different media reach and effectiveness. Newspapers may have stronger credibility and TV advertisements may have more recall. In totality, agencies do compile a measure of effectiveness of a marketing channel. The data about effectiveness may be based on the management's own experience, computed by external consultants or derived from merchant's own promotions through these channels and the measured outcome.

The cost of each marketing channel keeps changing depending on the business dynamics of that channel. While the cost of the print medium depends on the presence or absence of a sporting event, which may increase or decrease the readership and hence the per unit cost of using the medium, the cost of newsletter sent to each customers depends on the cost of mailing. Cost of telemarketing depends on the infrastructure cost of maintaining the call centers and the variable cost of hiring Customer Service Representatives and the communication cost paid to the telecommunications company providing the connectivity. Cost of web-based interface depends on the cost of changing the interface to deploy the initiative and in case the initiative is personalized, the cost of personalization, which includes the server time consumed in personalizing the content. The merchant might obtain the estimate of cost of each channel based on the actual costs incurred over time or from business experts who rely on their industry experience to define the benchmark costs.

Library of Shopper Profile 208 comprises shoppers' demographics (including income, age, gender, geographical location, interest, hobbies), derived measures from purchase history, and from the response to various marketing initiatives. For example, response to coupon offers, advertisements, product news letters, web browsing click stream, surveys, feedback letters, complaints, e-mail communication, record of verbal exchanges over with merchant's representatives along with the channel across which the customer-merchant interaction took place etc. The differential response of customer across different marketing channels represents customer preference for a channel. For example, if a customer has responded more to e-mail promotions as compared to mail-in-rebates, the preferred channel for the customer is e-mail. The derived measures may be recency, frequency and amount measures over each of these marketing initiatives or observations. The time gap between response and the initiative being exposed to the shopper could also be used in computing the derived measures.

For example, for coupon usage, following can be used as derived measures comprising the state of the shopper: number of coupons used till date, number of coupons received till date, number of coupons used in last 6 months, number of coupons received in last 6 months, total amount of discount received till date, highest value of coupon redeemed, lowest value of coupon redeemed, maximum number of coupons redeemed in a month, and so on.

Summarization of past purchase histories and action histories is done through a “modified” RFM (Recency, Frequency, and Monetary Value) measures which weighs the corresponding measures using “eligibility trace” technique. That is, a time-decaying function, such as a negative exponential (if discrete time epochs are sufficiently close) or any geometrically decaying function, is coupled with the RFM measures to measure “relative” effectiveness of customer purchase histories. For example, the purchases of a customer may be summarized by the amount of purchases made in each category. To aggregate the purchase made in each category, the past purchases are multiplied with a time decay factor (more weight to recent purchases, say in the last week and less weight to purchases one month back). Since the aggregation uses all purchases, it accounts for frequency; decaying factor accounts for recency; and since the aggregation is done on amount of money spent—it accumulates monetary value, hence the name RFM. Each customer would therefore have a numerical value for each category of products sold by the merchant representing the interest of that customer in that category. The aggregation can be performed at the sub-category level or some categories may further be aggregated. Another method of aggregation may actually use product attributes and then aggregate based on the attribute values.

The modified RFM value, m(pₜ) of a customer's purchase history pₜ up to time t, is computed as:

$$m ( {p}_{t} ) = {\sum }_{j ∈ {H}_{t}}^{} {β}^{{τ}_{k}} {X}_{j}$$

where xⱼ is the monetary value of the j-th purchase, Hₜ is the set of purchases in a category ( for example, if customer makes 5 purchases by time t, then Hₜ={1,2,3,4,5}) and τⱼ is the number of time periods (say months) between the current time t and the j -th purchase. 0<β<1 is the decaying factor. To illustrate this for β=0.1, consider two purchases of value $50 in the last month and $100 a year ago from a customer: The actual monetary value of this purchase history in the current month is equivalent to 50(0.5)¹+100(0.5)¹²=25.012.

Through Merchant Objective Specification Tool 210, the merchant specifies an objective or a set of objectives for the next time period. The merchant may also guide the system by specifying the base marketing initiatives that can be chosen from library of base initiatives 202 or the strategies that can be adopted. Over a period of time, the system learns the relationship between objectives and their corresponding strategies. A learning algorithm uses the objectives and the optimal strategies recommended by the system as input and approximates the function that maps the objective to the recommended strategy and using the generalization of the learning algorithm, determines the possible strategies for a new objective specified by the merchant. For the purpose of better learning, the objectives can be classified based on different parameters. For example, what does an objective aims to do?
(a) Maximize or minimize,
(b) Focus on revenue, profit, market share, total volume sold, inventory reduction and so on. This list is build over time based on merchant input,
(c) The objects of consideration, that is, the products, categories, customer segment definitions, channels available and so on.

The list is built over time based on merchant inputs. The potential strategies specified by the merchant are also recorded by the system. After the learning, the system suggests some of the potential strategies which merchant may accept or reject and add some of his/her to the list. For example, consider Table 1 shown below. It indicates a list of strategies that can be used for increasing the revenues for merchant selling goods to consumers in different scenarios.

TABLE 1

| Business Objective | Possible Strategies |
|---|---|
| Existing customers | Increase frequency of consumption (loyalty |
| existing products | programs, cumulative purchase discount |
| | program) |
| | Increase purchase per visit (volume discounts) |
| | Offer cross promotion deals- bundle products |
| | and options (cross promotion bundling deals) |
| | Announce competition/games with prizes |
| Existing customer, new | In-store and out-of-store advertisements |
| products | Offer introductory discounts |
| | Fill Questionnaires, get discounts |
| | Samples- trial offers, free sops to loyal |
| | consumers of competition, |
| | Product bundling with his existing product |
| | preferences |
| | Offer enhanced product warranties to quality |
| | conscious buyers |
| Attract new customers | Pick specific high profile products for |
| | promotion and advertise them. |
| | Store advertisements |
| | Offer incentives for customer reference |
| | (conditions for reference validity) |
| | Convert casual surfers into consumers (offer |
| | incentives to register and buy) |
| | Free gifts on first purchase (random E- |
| | coupons) or no shipping charges etc. |
| | New product advertisements |
| | Organize event based promotions, build |
| | alliances for cross-references |
| Upgrade consumers | Offer trials of higher value products at lower |
| | price or same price as its existing product |

As depicted in Table 1 above, there can be several marketing strategies applicable. Based on user history such data can be collected and a more detailed form of Table 1 can be formed. In this manner, Merchant Objective Specification Tool 210 can directly select a set of viable strategies for a given objective. A text based or graphical user interface enables the merchant to enter the objective specification and the potential strategies for the objective.

The merchant also specifies the customer features that can be used for matching different customers and assigning them to different matched groups.

Alternative Marketing Strategies Enumeration Tool 212 generates a list of possible strategies for the provided objective. A marketing strategy comprises a set of one or more marketing communications or initiatives, which are deployed together in a given sequence for a specified period of time (which can be a decision epoch). A recommended strategy can be a single strategy or multiple strategies or in fact, more generally can be a randomization over a set of strategies. Marketing strategies are generated by first selecting at least one initiative that enables the addressing of the objective of the merchant. Thereafter, a sequence for deploying the initiative is determined. As defined above, the deployment of these initiatives is the determined sequence is the marketing strategy. For example, a recommended strategy (to be executed on an arriving customer) can be any one of the following three strategies: a discount offer coupon worth $50 for single redemption during a week, to be featured over (i) his mobile or (ii) a PC (assuming both the channels are feasible for that customer) or (iii) 50 percent of the time on each of these channels. Based on the specifications of the objective specified by the merchant or a company, a table map (similar to Table 1 shown above) enables the system to select from potential initiatives or promotions that can be combined together to form a marketing strategy.

Further constraints can be defined that can put limitations on strategies. The constraints may be cost based or may have the effect of reducing the search space of the available initiatives or the sequence in which they can be organized to form a strategy. For example, a merchant can specify to exclude discounts on the product for which a marketing strategy is being identified.

Alternative Marketing Strategies Enumeration Tool 212 comprises a number of operators that can be applied to initiatives to form the strategy. For example, these may include Deployed Time Reduction Operator, Deployed Time Increment Operator, Marketing Initiative Permutation Operator, Marketing Initiative Parameter Exploration Operator. The deployed time or the deployment time of an initiative is the time period or the duration for which it is deployed.
1. Deployed Time Reduction Operator generates a random variable between 0 and 1, say A and reduces the deployment time by multiplying it by A.
2. Deployed Time Increment Operator generates a random variable between 0 and 1, say A and increments the deployment time by dividing it by A.
3. Marketing Initiative Permutation Operator examines a strategy, which contains a sequence of initiatives, for example, ABCD and generates different permutations, for example, ADBC, ACBD, BCDA etc. This operator is important as the sequence in which initiatives are deployed can impact the revenue generated from a customer.
4. Marketing Initiative Parameter Exploration Operator: Each marketing initiative has a set of parameters. For example, a coupon contains parameter like offer conditions, redemption conditions and the monetary value. The merchant can define lower and upper bounds, or may be specific values that each parameter of an initiative can take. For example, a 5% coupon for V-neck Sweater may have lower bound of 0% and upper bound of 30%. The Marketing Initiative Parameter Exploration Operator can generate a new initiative A′ from A, by changing the monetary value of the coupon from 5% to 10%, 15% etc. The merchant can define in addition to the lower and the upper bounds, the steps in which the monetary value can change. In case of advertisement, the merchant can define specific marketing messages formats and limit the subject of the advertising text to specific product attributes or customer preferences.
   The purpose of the above operators is to explore the space of initiatives and strategies by changing the different parameters that characterize them. The Reinforcement Learning Algorithm uses the alternative strategies, generated by modification of existing strategies by application of these operators. In general, the exploration of the strategy space may further be controlled by a genetic algorithm, which may use the above operators as the mutation operators.

Based on the available list of initiatives and the operators, a set of marketing strategies is generated in order to meet the merchant objective.

Thereafter, these strategies are evaluated by reinforcement learning in constrained domains tool 214. This tool comprises an algorithm that evaluates these strategies based on the existing history of experiments, their context and the response to these experiments by specific customer segments. A filtered list is generated which maximizes the total expected information from the response to the experiments. For example, if the objective of the merchant is to maximize revenues over a certain period of time, the algorithm evaluates each strategy and deploys the strategy that is likely to generate the maximum revenues. The exact manner in which the reinforced learning algorithm works will be described in detail later.

In another embodiment of the present invention, historical data can be used to identify an optimal strategy and, thereafter, reinforcement learning in constrained domains tool 214 can be used to determine an optimal and feasible strategy based on channel constraints.

Having given an overview of the system of the current invention, the exact manner in which the different elements of the invention cooperate will be described hereinafter.

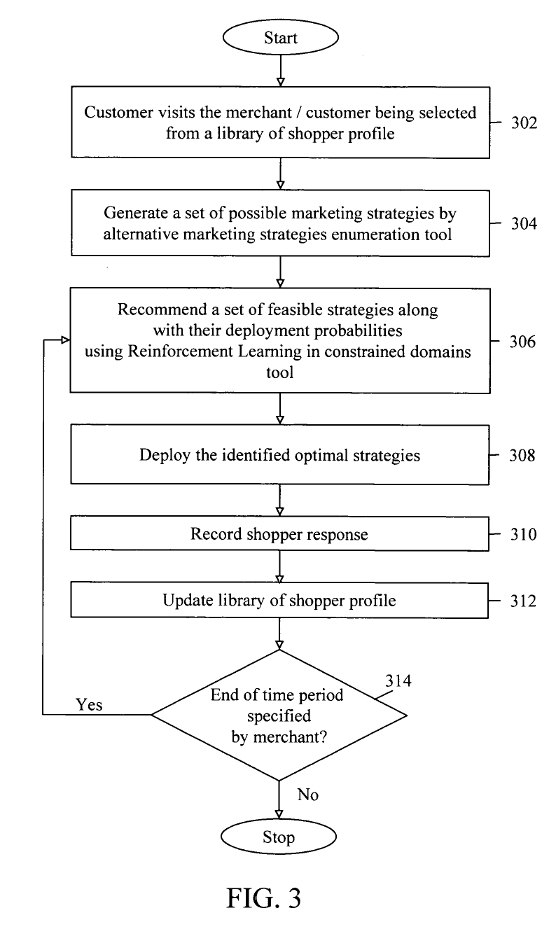

FIG. 3 is a flowchart depicting the interaction of a shopper with the system described in FIG. 2. A shopper visits the merchant at step 302. Thereafter, a set of marketing strategies are generated that can be applicable to the shopper at step 304. This is done through Alternative Marketing Strategies Enumeration Tool 212. Subsequently, reinforcement learning in constrained domains tool 214 recommends a set of feasible strategies along with their deployment probabilities at step 306. The exact manner in which these probabilities are calculated will be explained in detail in conjunction with the description of the RL algorithm in constrained domains. As mentioned in conjunction with FIG. 2, reinforcement learning in constrained domains tool 214 uses information on the shopper state from Library of Shopper Profile 208, if available. It also uses information on various marketing channels applicable to a strategy from library of marketing channels 204 and constraints applicable to these channels from Library of Cost and Effectiveness of Marketing Channels 206.

An optimal marketing strategy, selected from the set of feasible strategies obtained at step 306, is deployed at step 308. The exact manner of selection of the optimal strategy will be explained in detail later. Thereafter, shopper response is recorded at step 310. The shopper response may be logged on a commerce system when the shopper responds on an internet website, by a customer service representative while shopper is communicating with a call center, by a transaction system or the representative at the checkout counter in a brick and mortar store or by recording the visit to a specific page when shopper clicks on an URL link sent to the shopper through an e-mail. A customer relationship management system or an enterprise resource planning system might enable easier logging and tracking of customer response to different marketing strategies. Subsequently, library of shopper profile 208 is updated at step 312. At step 314, it is verified whether the planning horizon specified by the merchant has ended or not. Steps 306 to 314 are repeated in case the planning horizon specified by the merchant has not ended. This iterative scheme is followed for the planning horizon specified by the merchant. In this manner, the optimal strategy is regularly updated at every decision epoch in order to maximize the merchant's objective.

Reinforcement Learning in Constrained Domains

Prior to explaining the algorithm for reinforcement learning in constrained domains in accordance with the current invention, the concept of reinforcement learning and a basic algorithm for learning will be explained. Reinforcement Learning (RL) is an adaptive decision-making paradigm in a dynamic and stochastic environment. Based on Markov Decision Processes, the action and the expected response are function of the state of the system. In RL, a dynamic model captures the change in states depending on actions and rewards over time. The evolution of states has its own dynamics. An agent and his/her strategies modulate these dynamics. These, in turn, affect the costs (or pay-offs) experienced by the agent. For example, the state process is the movement in time of a customer over the feature space, which defines the state of a customer. This movement of state of a customer over time can be modified (or controlled) by marketing strategies being deployed by the merchant for the customer. Even without a conscientious marketing effort from the merchant (who is the agent here), a customer does make purchases to satisfy her needs and leaves a (digital) footprint with the merchant. This is described as natural dynamics of the underlying state process. If a customer is exposed to a set of marketing initiatives, then customer purchase behavior gets modified as a result. Such a modification results in a change of state and rewards for the merchant. The deployment of marketing strategy might imply that some costs have to be incurred by the merchant as well.

As a learning paradigm reinforcement learning algorithm falls somewhere in between the traditional paradigms of supervised learning and unsupervised learning. In supervised learning, a teacher gives an exact quantitative measure of the error made on each decision or action, on the basis of which the agent is expected to learn. In unsupervised learning, no such information is available and the agent essentially self-organizes. Some supervised learning examples are image retrieval and pattern recognition. A user (the supervisor) looking for a set of images is presented with a sample of images, to “learn” his interest (what type of images the user is looking for) and then retrieve all such samples from the database from the learnt experience. The user labels each individual image of the sample presented as “yes” or “no”. Thus the user acts here as a supervisor and his response “refines” the images to be retrieved in future. In reinforcement learning on the other hand, there is no supervisor, but there is a critic (to be explained in detail later) who gives a reinforcement signal positively correlated with the merits of the action taken by the agent. In case of reinforcement learning, the response of the shopper is not considered as “label” but a “signal” to reflect the imprecise nature of the response, which might positively or negatively reinforce the agent's belief. The customer is neither “supervisor” nor “teacher” but a “critic”. The agent uses these signals to improve his behavior over time and learns how to achieve the desired goal (or objective), which is a function of the received pay-offs (or reinforcement). For example, the immediate revenues earned by giving a promotional offer to an arriving customer, is “reinforcement”. Such a strategy might result in an increase in monetary value of the purchases made by the customer at that instant. However, the same strategy offered again to the same customer on his future visits may not have the same effect in monetary terms. Hence the strategy may be “very good” at some instant and be “not so good” at some other instant. Over all the strategy may be good on the average. Hence the exact measurement of “effectiveness” of the strategy is not possible, but the “goodness” is either positively or negatively reinforced on its successive executions over time.

The state of a shopper or a customer in the reinforcement learning algorithm is represented by the shopper profile from Library of Shopper Profile 208. The action space of the reinforcement learning algorithm comprises different marketing strategies that are generated by the Alternative Marketing Strategies Enumeration Tool 212.

A brief overview of reinforcement learning methodology described above will be provided hereinafter. A basic RL algorithm involves the following steps (please refer to glossary for details of terminology):

Let value of an action, a, in any given state, s, be denoted by Q(s, a), as the total expected reward if the decision-maker selects the action ‘a’ at the first time instant and follows an optimal policy from then on.

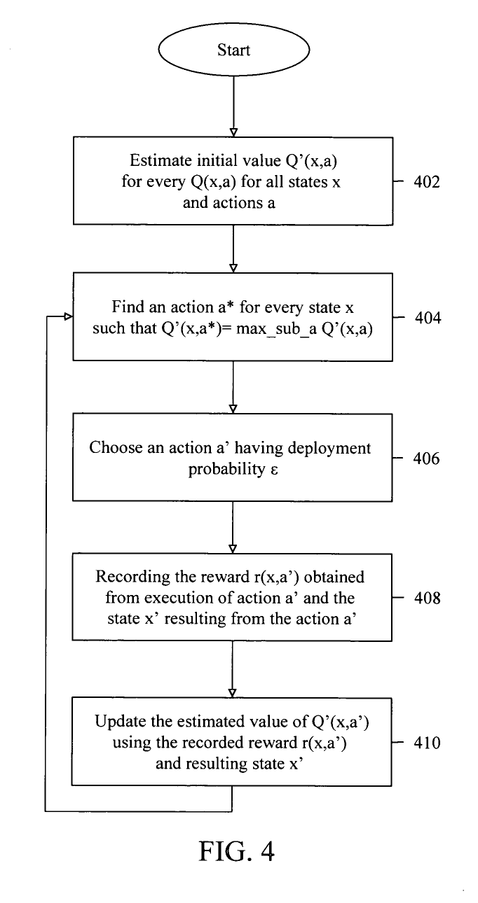

FIG. 4 is a flowchart depicting the reinforcement learning algorithm, as it exists in the art. Step 402 estimates an initial value, Q′(s,a) for all states s and actions a. At step 404 an action a* having the maximum estimated value of Q′(s,a) for a given state s is identified. That is, Q′(s,a′)=maxₐQ′(s,a). At step 406, an action a′ having deployment probability ε is chosen Step 406 uses the following randomization to select an action in state s for deployment to enable access by customers:

To allow for exploration of other actions, an action different from a* suggested in the algorithm is selected occasionally. This is done through some randomization. To draw an analogy, this randomization procedure can be viewed as tossing a biased coin (where heads and tails are not equally probable, rather head occurs with probability 1−ε and tails with probability ε for some positive ε>0. The coin is unbiased if ε=½. If tail results in head, a* is used in the execution. But if a toss results in tails, then any action (chosen arbitrarily or uniformly) other than a* is used for execution.

Corresponding to action a* with probability 1−ε another action a′ with probability ε for some positive ε>0 is selected. The action, a′ resulting from such randomization is then executed. At step 408 the reward r(s, a′) obtained from the execution of randomized action a′ and the new state, s′, resulting from this action is recorded.

At step 410 updating the current estimate of the value Q′(s,a′) is carried out as follows:
Q′(s,a′)←Q′(s,a′)+β[{r(s,a′)+γ max_{b}Q′(s′,b)}−Q′(s,a′)]

0<γ<1 above is called the discount factor and measures depreciation value or discounts for inflation and β is the learning rate parameter. It measures the value of reward discounted to the initial period. That is, it reflects the fact that $200 revenue earned say, a year after, is equivalent to $180 today. max_{b}Q′(s′,b) is the maximum Q value corresponding to state s′(b is the set of actions available in the new state s′).

Steps 404 to 410 are repeated iteratively in order to determine the best value for Q(s, a). In the above equation, the term
{r(s,a′)+γ max_{b}Q′(s′,b)}
is the sum of the immediate reward obtained from actual execution of action a′ and the current estimate of future expected reward from the resulting state s′. Hence, it is an intuitive measure to estimate the values of Q(s, a′) for state s from where the algorithm started. (Other intuitive measures used in practice are appropriate linear or polynomial functions of s and a). So adjustment of the current estimate of Q(s, a) is done in the direction of decreasing discrepancy. But instead of fully correcting the discrepancy, only a short step in that direction is taken. This is due to the fact that the same action in the same state does not give the same reward always because of the uncertainty involved. β determines the fractional move and is called the learning rate parameter.

All the existing RL algorithms are variants of the above basic procedure. But the above procedure is not suitable for online execution particularly in risk-sensitive commerce domains mainly because a truly optimal action is not selected until the “values” converge and to ensure convergence of values, there should be enough exploration of other actions having a deployment probability of ε parameter above. This exploration might result in a risky decision during the process of learning.

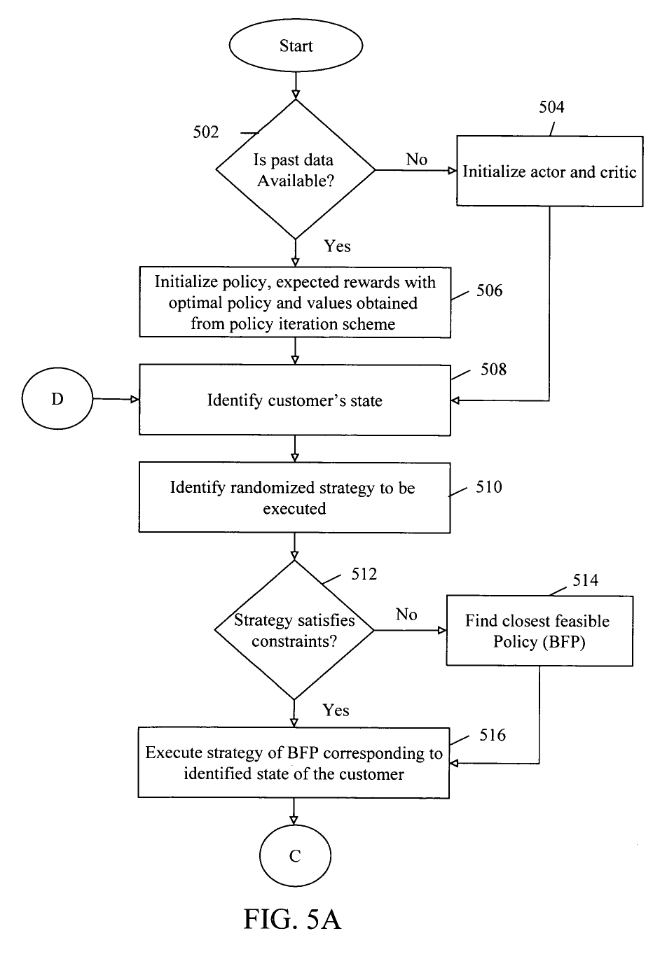

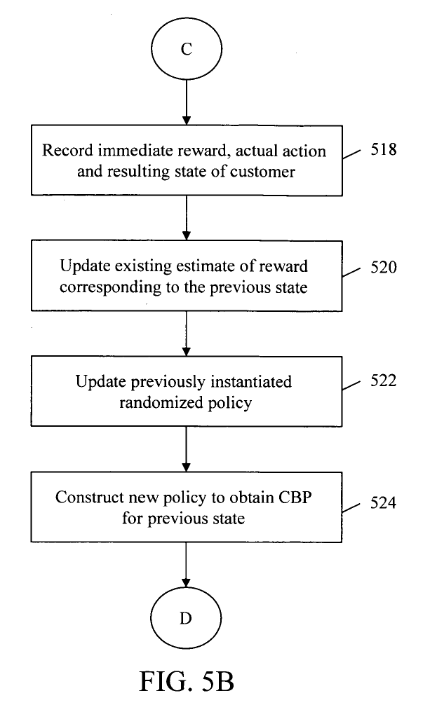

FIG. 5 (to be illustrated later) depicts constrained reinforcement learning algorithm in accordance with a preferred embodiment of the current invention. This modified algorithm deviates from the above traditional procedure to accommodate some constraints over the strategies that can be used over time. The traditional procedure updates only “values” and derives policy from those values. Hence there is no possibility of incorporating merchant specified constraints or any other constraints on strategies that arise out of budgetary considerations or out of customer's preference. For instance, the decision-maker might deduce from the profile of a customer that the customer has a preferred choice for a specific channel for exhibition of marketing activity. In general, the decisions suggested by the Reinforcement Learning over the selected channels are constrained as described by the Library of Cost and Effectiveness of Marketing Channels 206. Also, since a firm can have multiple-objectives, one may have to ensure certain minimal or maximal level of one objective while optimizing on the other. This feature also can be handled by designing a constraint on that objective.

The current invention also uses a procedure that involves coupled updates one for values and the other for policies (to be explained in detail later). Maintaining a separate update for policies offers flexibility with regard to dynamic invocation of constraints over the set of strategies. This RL procedure is described in detail in the next section.

Firstly, exact optimization of strategies over historical data is carried out. It is always advantageous to use exact optimization techniques to derive maximum benefit from available data. However, in this case, the state space is a high-dimensional object. Solving an exact dynamic model over this high-dimensional object suffers from computational complexity. Therefore, approximation techniques are applied to get the solution. These approximation techniques are numerical in nature and suffer from stability and convergence problems. Therefore, in the present invention, instead of developing an exact model and deriving approximate solutions, an approximate model is developed and solved exactly. The model is scalable and can be easily implemented. To this end, the original state space is discretized to handle the dimensionality issue and then an exact dynamic decision model is constructed over this new state space.

The value of a (unconstrained) policy π from state s, V^{π}(s), s ε S is defined as:
V^{π}(s)=Σₜγ^{t}rₜ(s,π(s)) Equation 1
where 0<γ<1 is the time-discount factor. The objective of the merchant is to find a policy π* that maximizes the above reward. Let V* denote the optimal value. Decision epochs are measured in discrete time units, but since “time to take decision” can be a function of observations, is in general a (discrete-valued) random variable.

In order to arrive at V* in an algorithmic fashion, initial estimate of V^{π} for some policy π is assumed. An initial policy and its corresponding value can be got from the historical policy and the resulting reward data. Denote this estimated value by V(π^{H}) where π^{H} is a historical policy followed over time. An algorithmic computation of V(π^{H}) is detailed below. These estimates are used to construct the discrete space S as follows.

Statespace Discretization Through Partitioning

Information about the shopper at each decision epoch t is described by k variables so that a point in k dimensional space represents the status of the customer at time t. Denote the state space, the Cartesian product of possible ranges of the k variables, by S′. A typical customer's behavior over time is a trajectory in S′.

Since S′ contains possible histories, it behaves like a Markovian space under any policy. However, since it is difficult to deal with such a high-dimensional object in optimization, discretization of the space to S using a response measure is done, namely the “the estimated value for following a (fixed or historical) policy”.

Draw an arbitrary separating hyperplane on the data space S′ that partition the space into S′₁ and S′₂. Now consider the segment, which has large variance across the data points with respect to the estimated value V (π^{H}), where π^{H} is the historic policy adopted Based on the historic policy, the actual rewards, the transition probabilities from one data point to another, a model is constructed to compute the value at all the data points. This segment say S′₁ is further segmented into two sub-partitions using the least square estimation.

A linear least square estimator a+b^{T}s′ is constructed for V (π^{H}) over S₁′ and the procedure is repeated until the variance across the values is within a (specified) tolerable limit. To minimize errors in consistency, the above hyperplanes can suitably be translated in the direction of minimal error, that is, find a parallel hyperplane such that it passes through the centroid of the data set S₁′. Now, each region lies at the intersection of some of the half spaces defined through the above hyperplanes. S is defined by an enumeration of these intersections.

No partitioning of the data space can be considered as a special case of partitioning when the number of partitions is so large that each partition has only one data point in its space.

Construction of a Sequential Decision Framework over S

Having constructed the discrete state space, one can define dynamic programming recursions on the state and action spaces as follows:
V*(s)=max_{π} E_{π,τ}[r(s,π(s))+γ^{τ} V*(s′)] Equation 2

The value V*(s) is the maximum value which is achievable for a given state of the customer and denotes the value of a state. In the spirit of policy iteration scheme of Markov Decision Processes (a popular model for sequential decision-making over time), policy evaluation function is defined for a fixed policy, π as given below:
V^{π}(s)=r′(s)+E_{τ,s′}[γ^{τ} V^{π}(s′)|s,π(s)] Equation 3
where r′(s) is the expected immediate reward for a given policy in the state s.

Evaluation of the conditional expectation here involves computation of transition probabilities to different states under policy π from the state s and also of expected transition duration to states'. To compute these terms the following steps are carried out:
1. From the past data, for different pairs (transition interval, the next state occupied) the aggregated frequency measure under the policy π using the discrete state space S for aggregation of frequencies is found.
2. These values of probabilities are encoded in the form of a matrix and use Gauss-Siedel iteration scheme (Reference: “Dynamic Programming and Optimal Control, 1995, Athena Scientific, Belmont, Mass. by D. Bertsekas”) to solve for V^{π}(s) in the above equation.

One need not maintain these matrices for all possible policies embedded in the data. It is enough to compute entries of the matrix only for those policies that appear in the following iterative scheme.

The Policy Iteration Scheme

The process starts with an initial policy that can be extracted from the past data. The initial policy can be chosen at random from the set of deterministic policies. The value of the initial policy is found by solving the following equation:
V^{π}(s)=r′(s,π(s))+E_{τ,s′}[γ^{τ} V^{π}(s′)|s,π(s)] Equation 5

A new improved policy π′ is constructed as given by the following equation:
π′(s)=arg max{r′(s,a)+E_{τ,s}[γ^{τ}V^{π}(s′)|s,a] Equation 6

Equations 5 and 6 are repeated until the policy does not change. This yields an exact optimal policy based on historical data. In Equation 6, a tie between policies may be broken using any fixed protocol.

Since the system determines the optimal policy for a given set of data, the merchant can use it in deciding his marketing strategies (actions) for a customer. If the customer has a purchase history, the customer is identified to belong to one of the segments designed earlier and hence, belongs to the state defined by the ordered-tuple of intersecting hyper-planes corresponding to that segment. Having identified the state, the marketing strategy to be followed over the next decision epoch can be directly obtained from the above optimal policy. The optimal policy gives the probability with which a strategy shall be followed. The strategy to be executed is determined by simulating a coin toss or a random number generator that simulates the probability distribution.

All the customers with no or minimal history are assigned the same state. In this case, the most optimal strategy is the offering of all feasible strategies at random with equal probabilities to the customers (there is no information to favor one strategy over the other). As the system explores new marketing strategies on the customer and accumulates data, the system arrives at an optimal policy through online learning.

Modeling Channel Constraints

The online learning follows a more general framework where the merchant might have technological constraints on the actions that can be used. For example, merchant when decides to send a promotional offer, he can exhibit the promotional offer on a PDA, or a web browser or on a mobile or all of them. A customer may have preferences for one of the channels. It is assumed that the Library of Shopper Profile 208 dynamically captures the shopper preference for a marketing channel. The preferred choice of the channel is modeled as choice constraints using integer variables and is an input to a constraint generator module. The preference can also modeled as a count of positive, neutral and negative response received from each of the channels. This constraint generator is then coupled to the Reinforcement Learning algorithm.

In addition to preference for the channel, the cost and the effectiveness of marketing channels imposes additional constraints that must be taken into account while exercising the channel option. An outside agent specifies the budgetary considerations that must be respected.

Two ways of handling such cost-based constraints are:

1. Formulate a budget constraint in terms of costs and append it to the constraint generator. In this case it is assumed that the constraint is linear and defines a simplex. In more general case, the constraint may have non-linear, that is, polynomial or exponential form.

For instance, assume that the cost for featuring a promotional offer over mobile devices once is $10 and the corresponding cost for PCs is $5, and for any other third channel $20. If the first option is used for n₁ time units and the latter for n₂ time units and the third channel for n₃ time units, the total cost incurred is 10n₁+5n₂+20n₃. This cost should not exceed the allocated budget, say B, for featuring across all channels. That is, 10n₁+5n₂+20n₃<B. This can be appended as a constraint to the set.

2. Another approach is to find a suitable combination of channels that meet the budgetary requirements and generate a choice constraint using integer variables on these channels.

Although two approaches have been suggested, it must be apparent to one skilled in the art that other approaches for handling cost based constraints can be used without deviating from the scope of the invention.

Online Learning—Updating Value and Policies

For the purpose of online learning a novel adaptive actor-critic type of algorithm has been developed for Reinforcement Learning. According to the terminology used in the Reinforcement Learning literature, Actor is a policy executor of the policy iteration scheme (see Equation 6) and Critic is the “evaluator” of the “actor” that measures effectiveness of the policy of the actor similar in spirit to Equation 5 in the policy iteration scheme.

In learning algorithms, no knowledge of transition probabilities is incorporated, as done by the policy iteration scheme. Equations 5 and 6 are replaced by numerical stochastic estimation schemes. To compute the value of a policy, a numerical scheme is used. This scheme solves the system of equations and replaces the conditional averaging (second term in Equation 5) with the actual value of the state that results from online execution of the action suggested by the policy in Equation 6. But note that underlying this step is an optimization exercise (since it involves selection of policy that maximizes the right hand side) and finds the best action from the available estimates of values. At this point of time, including the full-action space, the constraints indicated by the system are appended to the domain of optimization, so that the problem becomes a constrained optimization problem.

The constraints generated by the constraint module will involve choice of actions and is defined through integer variables. This integer nature of variables poses problems to the optimization exercise. As opposed to the traditional Reinforcement learning techniques, which find approximate solutions to exact models, an approximate model is developed and solved exactly. An advantage of the proposed method is that the exact solution, which is a policy, is fairly robust and also that the algorithm is scalable. This domain is converted to a convex set by allowing randomization over the actions and redefines the constraints in terms of the randomization.

For example, if the constraint restricts the promotions only to channels 1, 2 and 3, then the tuple (x₁, x₂, x₃) is associated with these channels. xᵢ can be interpreted as the probability of selecting channel i. The tuple must satisfy the constraint Σᵢ xᵢ=1, 0≦xᵢ≦1. If one of the solutions is (0.3, 0.4, 0.3), then one can implement such a policy in many possible ways. One option is to select channel 1 for 30 percent of the time, channel 2 for 40 percent of the time and channel 3 for 30 percent of the time. In summary, probability of deployment is associated over the set of feasible channels for a marketing strategy for a given state and constructs the constraint set.

A formal description of constraint-driven learning algorithm has been given below:
Vⁿ⁺¹(s)=Vⁿ(s)+b(nₛ)*Mₙ(s,d) Equation 7
π′ₙ₊₁(s,d)=πₙ(s,d)+a(n_{(s,d)})*Mₙ(s,d) Equation 8
πₙ₊₁(s)=Γ[π′ₙ₊₁(s)]Equation 9
where,
Mₙ(s,d)=[r(s,d)+γ^{t}Vⁿ(Xₙ)−Vⁿ(s)] Equation 10
d is the action actually executed in the previous state s. Xₙ is the actual state resulting from the action executed at time n. Vⁿ(s) is the estimate of the value of state s at time epoch n. nₛ is the number of times a state s results in n epochs. n_{(s,d)} is the number of times a state-action pair s and d results in n epochs. γ is the discount factor. Mₙ(s, d) is the relative merit of d, which is equal to the sum of the immediate reward and γ times the current estimate of the reward corresponding to the resulting state less the current estimate of the previous state. The value of the previous state s is updated based on Equation 7. t is the duration between two decision epochs.

Equation 8 updates the probability of the action executed d in π′ₙ₊₁(s) according to the relative merit Mₙ(s, d). If Mₙ(s, d) is positive, the action d is executed more frequently in future when the same state s is again encountered.
a(.) and b(.) are decreasing sequences such that lim_{n→∞}a(n)/b(n)=0.

The current best policy (CBP), without constraints, is π′ₙ₊₁(s).

The best feasible policy (BFP) is πₙ₊₁(s).

Γ is the projection operator that takes care of constraint space requirements. It projects the policy obtained from the original space π′ₙ₊₁(s) onto the policy space defined through the constraints, resulting in a new policy πₙ₊₁(s) (see Equation 9). If the constraint set is simply a choice constraint described above, then the above projection can be algorithmically computed in very simple steps. If it is defined through costs and the region is convex, then projection can again be computed using gradient descent algorithm for quadratic programs.

The constrained reinforcement algorithm is depicted in FIG. 5, which is also referred to as the actor-critic type of algorithm. At Step 502, past data is verified. If past data is not available, actor and critic are initialized at step 504. An arbitrary policy π₀(s) is instantiated in the actor. π₀(s) associates a randomized strategy to a customer state s. For critic, initial estimates of the Expected Rewards for each state are assigned arbitrarily.

If past data is available, the policy and expected rewards with the optimal policy and values obtained from Policy Iteration scheme are initialized at step 506. π₀(s) is set as the current best policy (CBP).

At step 508, the customer's state is identified. Further, the randomized strategy to be executed from the CBP is identified at step 510.

At step 512, the strategy as specified by the CBP is checked to see if it satisfies the constraints. If not, then at step 514, the BFP is obtained from the projection operator to find the closest feasible policy, (as depicted in Equation 9) where closeness is measured according to Euclidean distance in the space of the expected total rewards, that is, the values.

At step 516, the strategy of BFP corresponding to the identified state on the customer is executed.

At step 518, the immediate reward, actual action and the resulting state of the customer is recorded. This is similar in spirit to the traditional procedures described previously, but with a difference. At step 520, existing estimate of reward corresponding to the previous state by a weighted function is updated as given in Equation 7. Here, instead of using the policy derived from values of (state, action) pairs the most recent updated policy for online execution for a given state is used. And instead of maintaining values for different policies for a given state V^{π}(s), only the value of the most recently updated policy Vₙ₊₁(s)for a given state is maintained. This is done in the following manner: New estimate of the reward corresponding to the previous state=b(n) (current estimate of the previous state)+(1−b(n))*[immediate reward+γ current estimate of the reward corresponding to the resulting state] for some b(n) less than 1 where b(n) decreases with n, the number of times the state is visited. Repeat the procedure with state previous to the previous state and so on.

At step 522, previously instantiated randomized policy is updated. This is done by the following approach: Firstly, find the relative merit of the action executed in the previous state (Equation 10): immediate reward+γ current estimate of the reward corresponding to the resulting state-current estimate of the previous state. Subsequently, update the frequency (probability in the randomization) of the action executed according to the above relative merit (Equation 8). If the above difference is positive the action is executed more frequently in future when the same state is again encountered.

At step 524, another policy is constructed. For this an arbitrary ε>0 is selected. With ε the scheme that selects each action with equal probability (in each state) is chosen and with (1−ε) the one described in Step 524 is chosen. This forms the new CBP for the previous state and is stored.

Steps 510 to 524 are subsequently repeated for each customer.

Hardware and Software Implementation

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

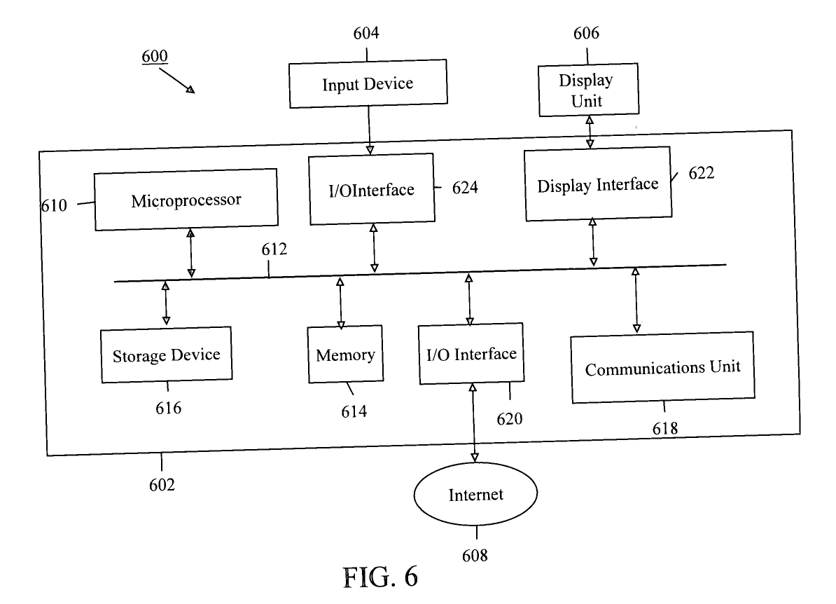

One such computer system has been illustrated in FIG. 6. The computer system 600 comprises a computer 602, an input device 604, a display unit 606 and the Internet 608. Computer 602 comprises a microprocessor 610. Microprocessor 610 is connected to a communication bus 612. Computer 602 also includes a memory 614. Memory 614 may include Random Access Memory (RAM) and Read Only Memory (ROM). Computer 602 further comprises storage device 616. It can be a hard disk drive or a removable storage drive such as a floppy disk drive, optical disk drive and the like. Storage device 616 can also be other similar means for loading computer programs or other instructions into the computer system. The computer system also includes a communication unit 618. Communication unit 618 allows the computer to connect to other databases and Internet 608 through an I/O interface 620. Communication unit 618 allows the transfer as well as reception of data from other databases. Communication unit 618 may include a modem, an Ethernet card or any similar device, which enables the computer system to connect to databases and networks such as LAN, MAN, WAN and the Internet. The computer system also includes a display interface 622 for connecting to display unit 606. The computer system facilitates inputs from a user through input device 604, accessible to the system through I/O interface 624.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as TCP/IP, UDP, ATM or OSI.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1-28. Cancel

29. A method for dynamically developing a marketing strategy to address at least one specified merchant objective, the objective corresponding to a specified time period and a specified budget, the strategy being implemented across at least one marketing channel, the strategy including at least one initiative, the method comprising the steps of:
a. generating a plurality of marketing strategies;
b. determining an optimal marketing strategy based on a state of a customer and constraints corresponding to marketing channels;
c. deploying the determined optimal marketing strategy;
d. recording customer response to the deployed optimal marketing strategy;
e. updating information corresponding to the state of a customer based on the recorded customer response; and
f. repeating steps b to e for the specified time period.

30. The method as recited in claim 29 wherein the step of generating a plurality of marketing strategies comprises the steps of:
selecting at least one initiative that enables an addressing of the specified objective;
determining sequences in which selected initiatives can be deployed, if more than one initiative is selected; and
combining the selected initiatives in the determined sequences to obtain the plurality of marketing strategies.

31. The method as recited in claim 30 further comprising varying parameters of initiatives to generate new initiatives.

32. The method as recited in claim 30 further comprising varying deployment time of initiatives.

33. The method as recited in claim 29 wherein the step of determining an optimal marketing strategy further comprises the steps of:
determining all possible states of customers;
determining an optimal policy for each state based on past data;
identifying the state of a customer, the customer visiting a merchant or the customer being selected from a database of customers; and
identifying an optimal marketing strategy using the state of the customer, the identified optimal policy and constraints corresponding to marketing channels.

34. The method as recited in claim 33 wherein the step of identifying all possible states of customers comprises the steps of:
identifying all relevant attributes of customers; and
partitioning the customers into partitions based on identified attributes using a similarity measure based on a historic policy, actual rewards and transition probabilities from one data point to another, the partitions forming new states of the customers.

35. The method as recited in claim 33 wherein the step of determining the optimal policy for each state based on past data comprises the steps of:
identifying a deterministic policy;
initializing a value of all possible states for the policy;
computing the value of a state for the policy;
repeating said step of computing for all possible states;
constructing a new improved policy;
iteratively performing steps of computing, repeating, and constructing until the new improved policy remains unchanged for two subsequent iterations; and
selecting the policy with maximum value for the state as the optimal policy for the given state.

36. The method as recited in claim 35 wherein the step of computing the value of a state for the policy comprises the steps of:
computing transition probabilities from a given state to another state for the policy;
computing value of expected immediate reward for the policy in the state;
computing discounted expected value of a resulting state for the policy; and
computing a sum of expected immediate reward and the discounted expected value.

37. The method as recited in claim 35 wherein the step of constructing a new improved policy comprises the steps of:
selecting the marketing strategy which maximizes a value for the state over all marketing strategies for a given state; and
repeating said step of selecting for each state.

38. The method as recited in claim 33 wherein the step of identifying an optimal marketing strategy comprises the steps of:
identifying the optimal policy for an identified customer state;
modeling customer's preferences for marketing channels, cost and effectiveness of different marketing channels, and the specified budget as effective constraints;
determining an optimal feasible policy based on the identified optimal policy and effective constraints corresponding to marketing channels; and
determining the optimal marketing strategy from the optimal feasible policy.

39. The method as recited in claim 38 wherein the step of determining an optimal feasible policy based on effective constraints corresponding to marketing channels comprises mapping the optimal policy uniquely to a closest feasible optimal policy based on the effective constraints, if the effective constraints are not satisfied by the optimal policy.

40. The method as recited in claim 29 wherein the step of updating information corresponding to the state of a customer based on the recorded customer response comprises the steps of:
identifying a resulting state of the customer;
updating values of the state of the customer; and
updating an optimal policy.

41. The method as recited in claim 40 wherein the step of updating the values of the state of the customer comprises:
computing a sum of a new immediate reward, a discounted value corresponding to the resulting state, reduced by a value corresponding to an initial state of the customer;
updating the values corresponding to the initial state of the customer by adding a fraction of the computed sum to a value of a previous state of the customer; and
propagating a change in the value of the state to all other states.

42. The method as recited in claim 40 wherein the step of updating the optimal policy comprises:
computing a sum of a new immediate reward, a discounted value corresponding to the resulting state, reduced by a value corresponding to an initial state of the customer; and
updating the optimal policy corresponding to an initial state of the customer by adding a fraction of the computed sum to the value of a previous state of the customer.

43. A system for dynamically developing a marketing strategy to address at least one specified merchant objective, the objective corresponding to a specified time period and a specified budget, the strategy being implemented across at least one marketing channel, the strategy including at least one initiative, the system comprising:
a generator operable for generating a plurality of marketing strategies;
a first unit operable for determining an optimal marketing strategy based on state of a customer and constraints corresponding to marketing channels;
a second unit operable for deploying the determined optimal marketing strategy;
a recorder operable for recording customer response to the deployed optimal marketing strategy; and
a third unit operable for updating information corresponding to the state of a customer based on the recorded customer response.

44. The system as recited in claim 43 wherein said generator comprises:
a selector operable for selecting at least one initiative that enables an addressing of the specified objective;
a first sub-unit operable for determining sequences in which selected initiatives can be deployed, if more than one initiative is selected; and
a second sub-unit for combining the selected initiatives in the determined sequences to obtain the plurality of marketing strategies.

45. The system as recited in claim 43 wherein the first unit comprises:
a first sub-unit operable for determining all possible states of customers;
a second sub-unit operable for determining an optimal policy for each state based on past data;
a third sub-unit operable for identifying the state of a customer, the customer visiting a merchant or the customer being selected from a database of customers;
a fourth sub-unit operable for identifying the optimal policy for an identified customer state;
a fifth sub-unit operable for modeling customer's preferences for marketing channels, cost and effectiveness of different marketing channels, and the specified budget as effective constraints;
a sixth sub-unit operable for determining an optimal feasible policy based on effective constraints corresponding to marketing channels; and
a seventh sub-unit operable for determining the optimal marketing strategy from the optimal feasible policy.

46. The system as recited in claim 45 wherein the second sub-unit comprises:
a first component operable for identifying a deterministic policy;
a second component operable for initializing a value of all possible states for the policy;
a third component operable for computing the value of a state for the policy;
a fourth component operable for constructing a new improved policy;
a fifth component operable for iteratively implementing said third component and said fourth component; and
a sixth component operable for selecting the policy with maximum value for the state as the optimal policy for the given state.

47. The system as recited in claim 46 wherein the fourth component comprises a selector operable for selecting the marketing strategy that maximizes a value for the state over all marketing strategies for a given state.

48. The system as recited in claim 43 wherein the third unit comprises:
a first sub-unit operable for identifying a resulting state of the customer;
a second sub-unit operable for updating a values of the state of the customer; and
a third sub-unit operable for updating an optimal policy.

49. A program storage device readable by computer, tangibly embodying a program of instructions executable by the computer to perform a method for dynamically developing a marketing strategy to address at least one specified merchant objective, the objective corresponding to a specified time period and a specified budget, the strategy being implemented across at least one marketing channel, the strategy including at least one initiative, the method comprising:
generating a plurality of marketing strategies;
determining an optimal marketing strategy based on state of a customer and constraints corresponding to marketing channels;
deploying the determined optimal marketing strategy;
recording customer response to the deployed optimal marketing strategy; and
updating information corresponding to the state of a customer based on the recorded customer response.

50. The program storage device as recited in claim 49 wherein the step of generating a plurality of marketing strategies comprises:
selecting at least one initiative that enables an addressing of the specified objective;
determining sequences in which selected initiatives can be deployed, if more than one initiative is selected; and
combining the selected initiatives in the determined sequences to obtain the plurality of marketing strategies.

51. The program storage device as recited in claim 49 wherein the step of determining an optimal marketing strategy comprises:
determining all possible states of customers;
determining an optimal policy for each state based on past data;
identifying the state of a customer, the customer visiting a merchant or the customer being selected from a database of customers;
identifying the optimal policy for an identified customer state;
modeling customer's preferences for marketing channels, cost and effectiveness of different marketing channels, and the specified budget as effective constraints;
determining an optimal feasible policy based on effective constraints corresponding to marketing channels; and
determining the optimal marketing strategy from the optimal feasible policy.

52. The program storage device as recited in claim 51 wherein the step of determining the optimal policy for each state based on past data comprises:
identifying a deterministic policy;
initializing a value of all possible states for the policy;
computing the value of a state for the policy;
constructing a new improved policy;
iteratively executing said steps of computing and constructing; and
selecting the policy with maximum value for the state as the optimal policy for the given state.

53. The program storage device as recited in claim 52 wherein the step of constructing a new improved policy comprises selecting the marketing strategy that maximizes a value for the state over all marketing strategies for a given state.

54. The program storage device as recited in claim 49 wherein the step of updating information corresponding to the state of a customer based on the recorded customer response comprises:
identifying a resulting state of the customer;
updating values of the state of the customer; and
updating an optimal policy.

55. A system suitable for developing an optimal marketing strategy, the system comprising:
a database storing information regarding initiatives that can be offered to customers, marketing channels available for executing the initiatives, cost and effectiveness of the marketing channels, and states of customers;
a unit operable for enabling a merchant to specify at least one objective for a specified time period;
a generator operable for generating a plurality of marketing strategies based on the objective specified by the merchant, the marketing strategies being a combination of initiatives; and
a component operable for determining the optimal marketing strategy and at least one marketing channel based on a state of a customer and cost and effectiveness of marketing channels.

56. A method for dynamically developing a marketing strategy to address at least one specified merchant objective, the objective corresponding to a specified time period and a specified budget, the strategy being implemented across at least one marketing channel, the strategy including at least one initiative, the method comprising the steps of:
a. generating a plurality of marketing strategies;
b. determining all possible states of customers;
c. determining an optimal policy for each state based on past data;
d. identifying the state of a customer, the customer visiting a merchant or the customer being selected from a database of customers;
e. identifying the optimal policy for an identified customer state;
f. modeling customer's preferences for marketing channels, cost and effectiveness of different marketing channels, and the specified budget as effective constraints;
g. determining an optimal feasible policy based on the identified optimal policy and effective constraints corresponding to marketing channels;
h. determining an optimal marketing strategy from the optimal feasible policy;
i. deploying the determined optimal marketing strategy;
j. recording customer response to the deployed marketing strategy;
k. identifying a resulting state of the customer;
l. updating values of the state of the customer;
m. updating the optimal policy; and
n. repeating steps c to m for the specified time period.
